(19) United States
(12) Patent Application Publication
(10) Pub. No.: US 2026/0151852 A1
(43) Pub. Date: Jun. 4, 2026

(54) COUPLING AND PACKAGING DEVICE AND METHOD FOR INTEGRATED HIGH-TEMPERATURE OPTICAL FIBER SENSOR BASED ON LASER FUSION SPLICING

(71) Applicant: NORTH UNIVERSITY OF CHINA, Taiyuan City (CN)

(72) Inventors: Jiamin Chen, Taiyuan City (CN); Yongqiu Zheng, Taiyuan City (CN); Yan Cao, Taiyuan City (CN); Chenyang Xue, Taiyuan City (CN); Jiandong Bai, Taiyuan City (CN); Xiwei Qin, Taiyuan City (CN)

(21) Appl. No.: 19/199,631

(22) Filed: May 6, 2025

(30) Foreign Application Priority Data
Dec. 2, 2024 (CN) 202411747352.3

(51) Int. Cl. B23K 26/21; B23K 26/324; G01M 11/00

(52) U.S. Cl. CPC B23K 26/21; B23K 26/324; G01M 11/30

(57) ABSTRACT

The present disclosure relates to the field of coupling and packaging of high-temperature sensors, in particular, to a coupling and packaging device and method for an integrated high-temperature optical fiber sensor based on laser fusion splicing. The device includes: a laser fusion splicing module, a motion control module, and a signal detection module, wherein the laser fusion splicing module is configured to provide fusion splicing laser to the motion control module to weld and fix a tail end of an optical fiber pigtail and a sensitive unit; the motion control module includes a three-dimensional displacement platform as pedestal, an optical fiber five-dimensional displacement platform, an optical fiber clamping member, a sensitive unit clamping member, a rotating platform, and a sensitive unit three-dimensional displacement platform, and is configured to achieve the alignment and adjustment of a fusion splicing position; and the signal detection module is configured to monitor a spectral signal in the sensor in real time. The present disclosure may achieve the integrated coupling and packaging of a homogeneous material of the high-temperature optical fiber sensor.

### TECHNICAL FIELD

The present disclosure relates to the field of coupling and packaging of high-temperature sensors, in particular, to a coupling and packaging device and method for an integrated high-temperature optical fiber sensor based on laser fusion splicing.

### BACKGROUND

With the rapid development of modern technology, the demand for high-temperature sensors in the fields of aerospace, energy, chemical industry, and the like increases day by day. In extreme environments such as high temperature, accurate measurement of parameters such as noise, vibration, pressure, strain, and refractive index not only concerns the performance and safety of the device, but also directly affects the production efficiency and product quality.

Restricted by blockade on techniques abroad, a high-temperature sensor directly affects the acquisition and application of related core technologies and products at home. Focusing on conventional electrical sensors at home, due to defects such as failure of a high-temperature structure, the electrical sensors are unable to work at the high-temperature condition stably for a long time, which significantly restricts the applicability and reliability of the electrical sensors in the high-temperature environment. In comparison, optical sensors have become the research hotspot in the field of sensors due to their advantages of low cost, small size, anti-electromagnetic interference, high-temperature resistance, and the like. However, most high-temperature optical fiber sensors are coupled with a high-temperature adhesive at present, which has a certain limitation in the high-temperature environment. This is mainly reflected in the inconsistency of the high-temperature adhesive and the material of the sensitive unit of the device, which will lead to thermal stress mismatch, so that the signal detection precision is affected. Moreover, the high-temperature adhesive is poor in long-term mechanical stability, and performance degradation of the high-temperature adhesive will occur after long-term high-temperature measurement.

Therefore, it is necessary to invent a coupling and packaging method for an integrated high-temperature optical fiber sensor to obtain an integrated sensor device based on a homogeneous material, which meets the development demand on high-temperature in-situ parameter test in the application fields such as oil exploration, aerospace, and nondestructive testing.

### SUMMARY

In order to overcome the technical bottleneck that in the prior art, a sensor is subjected to performance degradation at a high-temperature environment, the present disclosure provides a coupling and packaging device and method for an integrated high-temperature optical fiber sensor based on a carbon dioxide laser fusion splicing system, which get rid of the influence of thermal stress mismatch in a high-temperature environment on the signal detection precision, thereby improving the long-term stability of the sensor in the high-temperature environment.

In order to solve the above technical problem, the present disclosure adopts the following technical solution: a coupling and packaging device for an integrated high-temperature optical fiber sensor based on laser fusion splicing includes: a laser fusion splicing module, a motion control module, and a signal detection module, where
the laser fusion splicing module is configured to provide fusion splicing laser to the motion control module, so that a tail end of an optical fiber pigtail is fixed to a sensitive unit by fusion splicing;
the motion control module includes a three-dimensional displacement platform as pedestal, an optical fiber five-dimensional displacement platform, an optical fiber clamping member, a sensitive unit clamping member, a rotating platform, and a sensitive unit three-dimensional displacement platform; the optical fiber five-dimensional displacement platform and the sensitive unit three-dimensional displacement platform are fixed on the three-dimensional displacement platform as pedestal; the optical fiber clamping member is fixed on the optical fiber five-dimensional displacement platform; the sensitive unit clamping member is fixed on the rotating platform, and the rotating platform is fixed on the sensitive unit three-dimensional displacement platform; the optical fiber clamping member is configured to clamp the optical fiber pigtail, and the sensitive unit clamping member is configured to clamp the sensitive unit;
the optical fiber five-dimensional displacement platform is configured to cooperate with the sensitive unit three-dimensional displacement platform so as to achieve the alignment between the sensitive unit and the tail end of the optical fiber pigtail; the three-dimensional displacement platform as pedestal is configured to achieve the alignment between a fusion splicing position of the sensor and a focusing spot of the fusion splicing laser; and the rotating platform is configured to rotate the sensitive unit clamping member in a plane perpendicular to a direction of the optical fiber pigtail so as to achieve the switching of the fusion splicing position; and
the signal detection module includes a detection light source, a circulator and a spectrometer; the detection light source is connected to the optical fiber pigtail through the circulator, detection laser outputted by the detection light source is transmitted to the sensitive unit through the circulator and the optical fiber pigtail and is reflected back and forth between the sensitive unit and an end surface of the optical fiber pigtail to form dual-beam interference; and an interference signal outputted by the optical fiber pigtail is transmitted to the spectrometer through the circulator, and a spectral signal of the sensor is monitored in real time by the spectrometer.

The laser fusion splicing module includes a carbon dioxide laser device, a controller, a first light guide unit, a first variable beam expander and a first focusing lens; the controller is configured to adjust power of the laser outputted by the carbon dioxide laser device and time when the carbon dioxide laser device outputs the laser; laser outputted by the carbon dioxide laser passing through the first light guide unit, the first variable beam expander, and the first focusing lens is incident and focused to the fusion splicing position; and the first variable beam expander is configured to adjust a size of a spot of a laser beam, and the first focusing lens is configured to focus the laser beam.

The laser fusion splicing module further includes a beam splitter prism, a second light guide unit, a second variable beam expander, and a second focusing lens, the laser outputted by the carbon dioxide laser device passing through the first light guide unit is incident to the beam splitter prism and is divided into two beams by the beam splitter prism, and one of the beams passing through the first variable beam expander and the first focusing lens is incident and focused to the fusion splicing position, and the other one of the beams passing through the second light guide unit, the second variable beam expander, and the second focusing lens is incident and focused to another fusion splicing position.

The first light guide unit and the second light guide unit each include two 45°reflectors.

The coupling and packaging device for an integrated high-temperature optical fiber sensor based on laser fusion splicing further includes an electron microscope and a display screen, where the electron microscope is connected to the display screen and is configured to observe the fusion splicing position and a fusion splicing state of the sensor in real time.

A sensitive unit clamping area and a capillary tube clamping area are arranged on the sensitive unit clamping member; the capillary tube clamping area is configured to fix a capillary tube, and the optical fiber five-dimensional displacement platform is further configured to move the tail end of the optical fiber pigtail to achieve the alignment between the optical fiber pigtail with the capillary tube; and the sensitive unit clamping area is configured to fix the sensitive unit.

The sensitive unit clamping member includes a U pedestal, a first slide rail and a second slide rail are arranged in the U pedestal, a first slide block is arranged on the first slide rail, a second slide block is arranged on the second slide rail, and a first guide screw and a second guide screw are arranged on a side wall of the U pedestal, an end of the first guide screw contacts with the first slide block to push the first slide block to slide along the first slide rail, so as to fix the sensitive unit, and an end of the second guide screw contacts with the second slide block to push the second slide block to slide along the second slide rail, so as to fix the capillary tube.

The detection light source is an ASE light source, with a wavelength of 1550 nm.

In addition, the present disclosure further provides a coupling and packaging method for an integrated high-temperature optical fiber sensor based on laser fusion splicing, implemented based on the coupling and packaging device, where the method includes the following steps:
step 1: cleaning the sensitive unit and the capillary tube respectively and fixing the sensitive unit and the capillary tube in the sensitive unit clamping area and the capillary tube clamping area, and flatly cutting an end surface of the optical fiber pigtail and fixing the optical fiber pigtail to the optical fiber clamping member;
step 2: controlling the optical fiber five-dimensional displacement platform to move, so as to insert the optical fiber pigtail into the capillary tube, and keeping the end surface of the optical fiber flush with the end surface of the capillary tube;
step 3: controlling the three-dimensional displacement platform as pedestal to move so as to achieve the alignment between the fusion splicing position between the optical fiber pigtail and the capillary tube and the focusing spot of the fusion splicing laser; and controlling power of the laser outputted by the laser fusion splicing module and time when the laser fusion splicing module outputs the laser so as to achieve the fusion splicing between the capillary tube and the optical fiber pigtail;
step 4: after the fusion splicing of the capillary tube and the optical fiber pigtail is completed, taking out the capillary tube from the capillary tube clamping area, controlling the optical fiber five-dimensional displacement platform to move so as to insert the capillary tube into the sensitive unit; and controlling the three-dimensional displacement platform as pedestal to move so as to achieve the alignment between the fusion splicing position between the optical fiber pigtail and the capillary tube and the focusing spot of the fusion splicing laser;
step 5: monitoring an interference signal of the sensor in real time by the signal monitoring module, adjusting the optical fiber five-dimensional displacement platform and the sensitive unit three-dimensional displacement platform so as to change a relative angle and position between the capillary tube with the pigtail and the sensitive unit, until the interference signal detected by the signal monitoring module is the strongest; and then controlling the power of the laser outputted by the laser fusion splicing module and the time when the laser fusion splicing module outputs the laser so as to achieve the preliminary fusion splicing between the capillary tube and the sensitive unit; and
step 6: after the preliminary fusion splicing between the capillary tube and the sensitive unit is completed, releasing the optical fiber clamping member, controlling the rotating platform to rotate to drive the capillary tube and the sensitive unit to rotate, and performing fusion splicing on a next fusion splicing position between the capillary tube and the sensitive unit.

Step 3 specifically includes the following steps:
step 3.1: controlling the three-dimensional displacement platform as pedestal to move so as to achieve the alignment between the fusion splicing position between the optical fiber pigtail and the capillary tube and the focusing spot of the fusion splicing laser; and controlling the power of the laser outputted by the laser fusion splicing module and the time when the laser fusion splicing module outputs the laser so as to achieve the fusion splicing between the capillary tube and the optical fiber pigtail; and
step 3.2: controlling the three-dimensional displacement platform as pedestal to move along an axial direction of the optical fiber pigtail so as to achieve the alignment between a next axial fusion splicing position between the optical fiber pigtail and the capillary tube and the focusing spot of the fusion splicing laser, then controlling the power of the laser outputted by the laser fusion splicing module and the time when the laser fusion splicing module outputs the laser so as to achieve the fusion splicing between the capillary tube and the optical fiber pigtail, and then repeating the above steps so as to achieve the multi-position fusion splicing between the capillary tube and the optical fiber pigtail; and
step 6 specifically includes the following steps: after the preliminary fusion splicing between the capillary tube and the sensitive unit is completed, releasing the optical fiber clamping member, controlling the rotating platform to rotate to drive the capillary tube and the sensitive unit to rotate, controlling the three-dimensional displacement platform as pedestal to move so as to achieve the alignment between a next fusion splicing position on a same circumference between the optical fiber pigtail and the capillary tube and the focusing spot of the fusion splicing laser, and performing fusion splicing on the next fusion splicing position between the capillary tube and the sensitive unit.

Compared with the prior art, the present disclosure has the following beneficial effects:
1. The coupling and packaging device for an integrated high-temperature optical fiber sensor provided by the present disclosure is integrated with the laser fusion splicing module, the motion control module, the signal monitoring module, and a spatial five-axis system, which may improve the fusion splicing and coupling accuracy of the device. The skillfully designed clamp is compatible with different structures to be welded, and in the laser fusion splicing process, the signal of the sensing device may be monitored in real time and optimally adjusted. The present disclosure may improve the manufacturing efficiency of the device while guaranteeing that the integrated sensor has excellent overall performance.
2. Aiming at the sensitive unit, capillary tube, and optical fiber pigtail of the homogeneous glass material, the present disclosure replaces a conventional high-temperature adhesive coupling and packaging method with laser fusion splicing, which may achieve the integrated coupling and packaging of the homogeneous material and eliminate the problem of thermal stress mismatch among different material in the high-temperature environment, thereby improving the in-situ detection measurement precision and long-term stability of the sensor.

### BRIEF DESCRIPTION OF DRAWINGS

FIG. 1 is a schematic structural diagram of a coupling and packaging device for a high-temperature sensor provided in Embodiment I of the present disclosure;

FIG. 2 is a schematic structural diagram of a motion control system used in embodiments of the present disclosure;

FIG. 3 is a schematic structural diagram of a sensitive unit clamping member in embodiments of the present disclosure;

FIG. 4 is a schematic structural diagram of a coupling and packaging device for a high-temperature sensor provided in Embodiment II of the present disclosure;

FIG. 5 is a schematic diagram of each laser fusion splicing point in embodiments of the present disclosure; and

FIG. 6 is a schematic diagram of each laser fusion splicing point in embodiments of the present disclosure.

In the drawings,
1—carbon dioxide laser device
2—controller
3—first 45° reflector
4—second 45° reflector
5—beam splitter prism
6—first variable beam expander
7—first focusing lens
8—third 45° reflector
9—fourth 45° reflector
10—second variable beam expander
11—second focusing lens
12—detection light source
13—circulator
14—spectrometer
15—three-dimensional displacement platform as pedestal
16—optical fiber five-dimensional displacement platform
17—optical fiber clamping member
18—sensitive unit clamping member
19—rotating Platform
20—sensitive unit three-dimensional displacement platform
21—sensitive unit
22—capillary tube
23—optical fiber pigtail
24—electron microscope
25—display screen
18-1—U pedestal
18-2—first slide rail
18-3—second slide rail
18-4—first slide block
18-5—second slide block
18-6—first lead screw
18-7—second lead screw
26-1—first fusion splicing position
26-2—second fusion splicing position
26-3—third fusion splicing position
26-4—fourth fusion splicing position

### DETAILED DESCRIPTION OF THE EMBODIMENTS

To make the objectives, technical solutions, and advantages of the embodiments of the present disclosure clearly, the technical solutions in the embodiments of the present disclosure will be clearly and completely described below. Apparently, the described embodiments are a part of the embodiments of the present disclosure, rather than all the embodiments. On the basis of the embodiments in the present disclosure, all other embodiments obtained by those of ordinary skill without creative efforts all fall within the protection scope of the present disclosure.

### Embodiment I

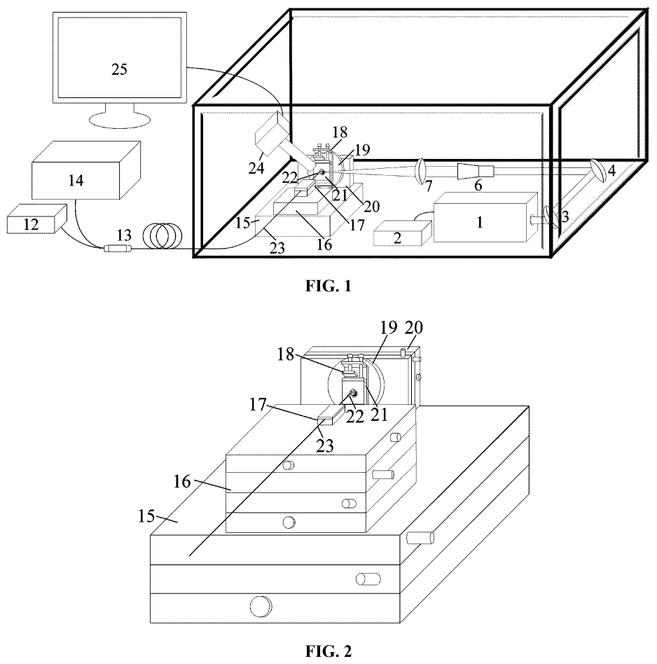

As shown in FIG. 1, Embodiment I of the present disclosure provides a coupling and packaging device for an integrated high-temperature optical fiber sensor based on laser fusion splicing, including: a laser fusion splicing module, a motion control module, and a signal detection module, where the laser fusion splicing module is configured to provide fusion splicing laser to the motion control module, so that a tail end of an optical fiber pigtail 23 is fixed to a sensitive unit 21 by fusion splicing.

Specifically, as shown in FIGS. 1-2, the motion control module includes a three-dimensional displacement platform as pedestal 15, an optical fiber five-dimensional displacement platform 16, an optical fiber clamping member 17, a sensitive unit clamping member 18, a rotating platform 19, and a sensitive unit three-dimensional displacement platform 20; the optical fiber five-dimensional displacement platform 16 and the sensitive unit three-dimensional displacement platform 20 are fixed on the three-dimensional displacement platform as pedestal 15; the optical fiber clamping member 17 is fixed on the optical fiber five-dimensional displacement platform 16; the sensitive unit clamping member 18 is fixed on the rotating platform 19, and the rotating platform 19 is fixed on the sensitive unit three-dimensional displacement platform 20; the optical fiber clamping member 17 is configured to clamp the optical fiber pigtail 23, and the sensitive unit clamping member 18 is configured to clamp the sensitive unit 21. In addition, the motion control module further includes a control module, configured to control actions of the three-dimensional displacement platform as pedestal 15, the optical fiber five-dimensional displacement platform 16, the optical fiber clamping member 17, the sensitive unit clamping member 18, the rotating platform 19, and the sensitive unit three-dimensional displacement platform 20.

In the present embodiment, the optical fiber five-dimensional displacement platform 16 is configured to cooperate with the sensitive unit three-dimensional displacement platform 20 to achieve the alignment between the sensitive unit 21 and the tail end of the optical fiber pigtail 23; the three-dimensional displacement platform as pedestal 15 is configured to achieve the alignment between a fusion splicing position of the sensor and a focusing spot of laser fusion splicing; and the rotating platform 19 is configured to rotate the sensitive unit clamping member 18 in a plane perpendicular to a direction of the optical fiber pigtail 23 so as to achieve the switching of the fusion splicing position.

Specifically, as shown in FIGS. 1-2, the signal detection module includes a detection light source 12, a circulator 13, and a spectrometer 14, where the detection light source 12 is connected to the optical fiber pigtail 23 through the circulator 13, detection laser outputted by the detection light source 12 is transmitted to the sensitive unit 21 through the circulator 13 and the optical fiber pigtail 23 and is reflected back and forth between the sensitive unit 21 and an end surface of the optical fiber pigtail 23 to form dual-beam interference; and an interference signal outputted by the optical fiber pigtail 23 is transmitted to the spectrometer 14 through the circulator 13, and the spectral signal of the sensor is monitored in real time by the spectrometer 14.

Specifically, as shown in FIG. 1, in the present embodiment, the laser fusion splicing module includes a carbon dioxide laser device 1, a controller 2, a first light guide unit, a first variable beam expander 6, and a first focusing lens 7; the controller 2 is configured to adjust power of the laser outputted by the carbon dioxide laser device 1 and time when the carbon dioxide laser device outputs the laser; laser outputted by the carbon dioxide laser device 1 passing through the first light guide unit, the first variable beam expander 6, and the first focusing lens 7 is incident and focused to the fusion splicing position; and the first variable beam expander 6 is configured to adjust a size of a spot of a laser beam, and the first focusing lens 7 is configured to focus the laser beam.

Specifically, in the present embodiment, the first light guide unit includes a first 45° reflector 3 and a second 45° reflector 4, and the two 45° reflectors may achieve the adjustment of a light path.

Further, the coupling and packaging device for an integrated high-temperature optical fiber sensor based on laser fusion splicing in the present embodiment further includes an electron microscope 24 and a display screen 25, where the electron microscope 24 is connected to the display screen and is configured to observe the fusion splicing position and a fusion splicing state of the sensor in real time.

Further, the coupling and packaging device for an integrated high-temperature optical fiber sensor based on laser fusion splicing in the present embodiment further includes a shell, where the electron microscope 24, the laser fusion splicing module, and the motion control module all are arranged in the shell. The shell may prevent the device from external disturbance, and the alignment condition of each structure of the sensor may be monitored in real time by the electron microscope 24.

In the present embodiment, taking the direction where the optical fiber pigtail 23 is located as a Y axis and the plane where the optical fiber clamping member 17 is located as an XY plane, the three-dimensional displacement platform as pedestal 15 may translate in X, Y, and Z axial directions. The optical fiber five-dimensional displacement platform 16 can not only move in the X, Y, and Z axial directions, but also rotate in the X and Z axis directions to achieve the adjustment of the pitch angle. The sensitive unit three-dimensional displacement platform 20 may be adjusted in the X, Y, and Z axial directions. The three displacement platforms constitute a spatial five-axis system, which ensures that a laser beam arrives at a position to be welded accurately, thereby improving the precision and efficiency of the fusion splicing process. Moreover, the electron microscope 24 is connected to the display screen 25 to observe the fusion splicing state of the sensor in real time.

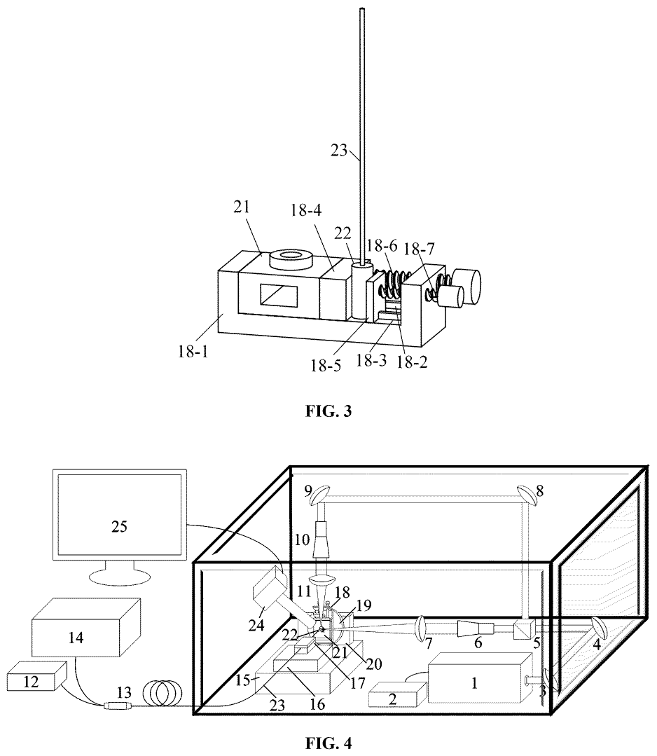

Further, in the present embodiment, besides the optical fiber pigtail 23 and the sensitive unit 21, a sensor to be packaged further includes a capillary tube 22. The tail end of the optical fiber pigtail 23 is fixedly arranged in the capillary tube 22 by fusion splicing, and the capillary tube 22 is fixed at the center of the sensitive unit 21 by fusion splicing. As shown in FIG. 3, a sensitive unit clamping area and a capillary tube clamping area are arranged on the sensitive unit clamping member 18; the capillary tube clamping area is configured to fix a capillary tube 22, and the optical fiber five-dimensional displacement platform 16 is further configured to move the tail end of the optical fiber pigtail 23 to achieve the alignment between the optical fiber pigtail 23 with the capillary tube 22; and the sensitive unit clamping area is configured to fix the sensitive unit 21.

Further, as shown in FIG. 4, in the present embodiment, the sensitive unit clamping member 18 includes a U pedestal 18-1, a first slide rail 18-2 and a second slide rail 18-3 are arranged in the U pedestal 18-1, a first slide block 18-4 is arranged on the first slide rail 18-2, a second slide block 18-5 is arranged on the second slide rail 18-3, and a first guide screw 18-6 and a second guide screw 18-7 are arranged on a side wall of the U pedestal 18-1, an end of the first guide screw 18-6 contacts with the first slide block 18-4 to push the first slide block 18-4 to slide along the first slide rail 18-2, so as to fix the sensitive unit 21, and an end of the second guide screw 18-7 contacts with the second slide block 18-5 to push the second slide block 18-5 to slide along the second slide rail 18-3, so as to fix the capillary tube 22.

Specifically, in the present embodiment, an end of the first guide screw 18-6 contacts with the first slide block 18-4 to push the first slide block 18-4 to slide along the first slide rail 18-2, so as to fix the sensitive unit 21 between the first slide block 18-4 and the other side wall of the U pedestal 18-1; and the second slide block 18-5 is arranged between a side wall of the U pedestal 18-1 and the first slide block 18-4, and an end of the second guide screw 18-7 contacts with the second slide block 18-5 to push the second slide block 18-5 to slide along the second slide rail 18-3, so as to fix the capillary tube 22 between the first slide block 18-4 and the second slide block 18-5.

Specifically, in the present embodiment, the detection light source 12 is an ASE light source, with a wavelength of 1550 nm. A wavelength of the carbon dioxide laser device 1 is 10.6 μm. The first variable beam expander 6 and the first focusing lens 7 may adjust the spot to about 1 mm, so that the laser beam works effectively on the capillary tube 22 with the pigtail. The capillary tube 22 is made of a glass material, and after absorbing the energy of the laser, the glass converts the energy into thermal energy, which results in melting of the material, so that a laser fusion splicing effect is achieved.

### Embodiment II

As shown in FIG. 4, an embodiment of the present disclosure provides a coupling and packaging device for an integrated high-temperature optical fiber sensor. Same as the Embodiment I, the coupling and packaging device for an integrated high-temperature optical fiber sensor includes a laser fusion splicing module, a motion control module, and a signal detection module, where the laser fusion splicing module includes a carbon dioxide laser device 1, a controller 2, a first light guide unit, a first variable beam expander 6, and a first focusing lens 7.

Different from Embodiment I, in the present embodiment, the laser fusion splicing module further includes a beam splitter prism 5, a second light guide unit, a second variable beam expander 10, and a second focusing lens 11. Laser outputted by the carbon dioxide laser device 1 passing through the first light guide unit is incident to the beam splitter prism 5 and is divided into two beams by the beam splitter prism 5, where a first beam passing through the first variable beam expander 6 and the first focusing lens 7 is incident and focused to a fusion splicing position, and a second beam passes through the second light guide unit, a direction of propagation of the second beam is perpendicular to a direction of propagation of the first beam, and then the second beam passing through the second variable beam expander 10 and the second focusing lens 11 is incident and focused to another fusion splicing position.

In the present embodiment, the fusion splicing laser is divided into two beams by the beam splitter prism 5, so that different positions of the sensor may be welded simultaneously, thereby further improving the coupling and packaging efficiency of the sensor. A splitting ratio of the beam splitter prism 5 is 1:1.

Specifically, in the present embodiment, the second light guide unit includes a third 45° reflector 8 and a fourth 45° reflector 9, and the two 45° reflectors may achieve the adjustment of a light path of the second beam.

### Embodiment III

The Embodiment III of the present disclosure provides a coupling and packaging method for an integrated high-temperature optical fiber sensor based on laser fusion splicing, implemented based on the coupling and packaging device in the Embodiment I or II, where the method includes the following steps:
step 1: the sensitive unit 21 and the capillary tube 22 are cleaned respectively and the sensitive unit and the capillary tube are fixed in the sensitive unit clamping area and the capillary tube clamping area, and an end surface of the optical fiber pigtail 23 is flatly cut and the optical fiber pigtail is fixed to the optical fiber clamping member 17;
step 2: the optical fiber five-dimensional displacement platform 16 is controlled to move so as to insert the optical fiber pigtail 23 into the capillary tube 22, and the end surface of the optical fiber is kept flush with the end surface of the capillary tube;
step 3: the three-dimensional displacement platform as pedestal 15 is controlled to move so as to achieve the alignment between the fusion splicing position between the optical fiber pigtail 23 and the capillary tube 22 and the focusing spot of the fusion splicing laser; and power of the laser outputted by the laser fusion splicing module and time when the laser fusion splicing module outputs the laser are controlled so as to achieve the fusion splicing between the capillary tube 22 and the optical fiber pigtail 23;

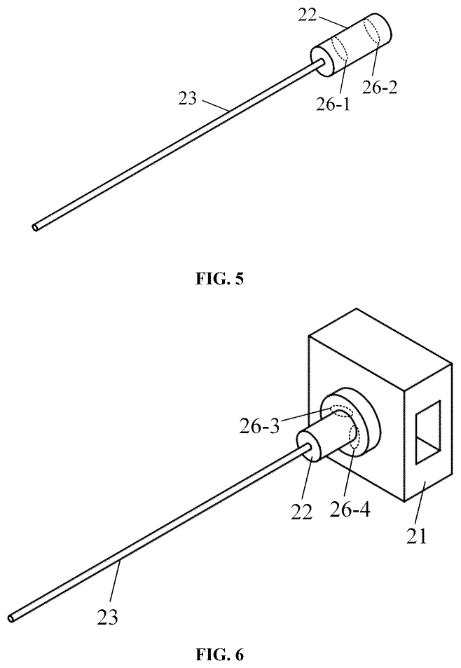

step 3 specifically includes the following steps:
step 3.1: the three-dimensional displacement platform as pedestal 15 is controlled to move so as to achieve the alignment between the fusion splicing position between the optical fiber pigtail 23 and the capillary tube 22 and the focusing spot of the fusion splicing laser; and the power of the laser outputted by the laser fusion splicing module and the time when the laser fusion splicing module outputs the laser are controlled so as to achieve the fusion splicing between the capillary tube 22 and the optical fiber pigtail 23; and
step 3.2: the three-dimensional displacement platform as pedestal 15 is controlled to move along an axial direction of the optical fiber pigtail 23 so as to achieve the alignment between a next axial fusion splicing position between the optical fiber pigtail 23 and the capillary tube 22 and the focusing spot of the fusion splicing laser, then the power of the laser outputted by the laser fusion splicing module and the time when the laser fusion splicing module outputs the laser are controlled so as to achieve the fusion splicing between the capillary tube 22 and the optical fiber pigtail 23, and then the above steps are repeated so as to achieve the multi-position fusion splicing between the capillary tube 22 and the optical fiber pigtail 23;
as shown in FIG. 5, a first fusion splicing position 26-1 and a second fusion splicing position 26-2 are axially arranged between the capillary tube 22 and the optical fiber pigtail 23; by means of a plurality of fusion splicing positions, it may be ensured that the capillary tube 22 and the optical fiber pigtail 23 are stably connected;
step 4: after the fusion splicing of the capillary tube 22 and the optical fiber pigtail 23 is completed, the capillary tube 22 is taken out from the capillary tube clamping area 18, the optical fiber five-dimensional displacement platform 16 is controlled to move so as to insert the capillary tube 22 into the sensitive unit 21; and the three-dimensional displacement platform as pedestal 15 is controlled to move so as to achieve the alignment between the fusion splicing position between the optical fiber pigtail 23 and the capillary tube 22 and the focusing spot of the fusion splicing laser;
step 5: an interference signal of the sensor is monitored in real time by the signal monitoring module, the optical fiber five-dimensional displacement platform 16 and the sensitive unit three-dimensional displacement platform 20 are adjusted so as to change a relative angle and position between the capillary tube 22 with the pigtail and the sensitive unit 21, until the interference signal detected by the signal monitoring module is the strongest; and then the power of the laser outputted by the laser fusion splicing module and the time when the laser fusion splicing module outputs the laser are controlled so as to achieve the preliminary fusion splicing between the capillary tube 22 and the sensitive unit 21; and
step 6: after the preliminary fusion splicing between the capillary tube 22 and the sensitive unit 21 is completed, the optical fiber clamping member 17 is released, the rotating platform 19 is controlled to rotate to drive the capillary tube 22 and the sensitive unit 21 to rotate, and fusion splicing is performed on a next fusion splicing position between the capillary tube 22 and the sensitive unit 21.

Further, step 6 specifically includes the following steps: after the preliminary fusion splicing between the capillary tube 22 and the sensitive unit 21 is completed, the optical fiber clamping member 17 is released, the rotating platform 19 is controlled to rotate to drive the capillary tube 22 and the sensitive unit 21 to rotate, the three-dimensional displacement platform as pedestal 15 is controlled to move so as to achieve the alignment between a next fusion splicing position on a same circumference between the optical fiber pigtail 23 and the capillary tube 22 and the focusing spot of the fusion splicing laser, and fusion splicing is performed on the next fusion splicing position between the capillary tube 22 and the sensitive unit 21.

As shown in FIG. 6, in the present embodiment, a third fusion splicing position 26-3 and a fourth fusion splicing position 26-4 are arranged on the same circumference between the capillary tube 22 and the sensitive unit 21. By means of the plurality of fusion splicing positions, it may be ensured that the capillary tube 22 and the sensitive unit 21 are stably connected.

In addition, 4 fusion splicing positions may be arranged on the same circumference between the capillary tube 22 and the sensitive unit 21, 2 positions may be welded at one time under a condition that the laser fusion splicing module outputs two fusion splicing lasers, and then the rotating platform 19 is rotated once to achieve fusion splicing of all fusion splicing positions.

To sum up, the present disclosure provides a coupling and packaging device and method for an integrated high-temperature optical fiber sensor based on laser fusion splicing. The whole sensor uses the integrated coupling and packaging method of the homogeneous material, which may solve the problems of low measurement precision and poor stability of the sensor caused by thermal stress mismatch between heterogeneous materials, and may further get rid of limitation on the working temperature of the sensor by the high-temperature adhesive, making in-situ high-precision sensing measurement at a higher temperature possible; and the integrated optical fiber sensor which is high-temperature resistant, highly reliable, and highly precise may be prepared rapidly and efficiently with low cost, so that the present disclosure is applicable to in-situ parameter detection in the fields such as aerospace, oil exploration, and nondestructive testing in extreme environments.

Finally, it should be noted that the above embodiments are merely used to illustrate the technical solutions of the present disclosure, rather than limiting the technical solution; although the present disclosure is described in detail with reference to the above embodiments, those of ordinary skill in the art should understand that they still can modify the technical solutions recorded in the embodiments described above or equivalently replace part of or all technical features therein; and these modifications or replacements do not make the essence of the corresponding technical solutions deviate from the scope of the technical solutions of the embodiments of the present disclosure.

1. A coupling and packaging device for an integrated high-temperature optical fiber sensor based on laser fusion splicing, comprising a laser fusion splicing module, a motion control module, and a signal detection module, wherein
the laser fusion splicing module is configured to provide fusion splicing laser to the motion control module, so that a tail end of an optical fiber pigtail is fixed to a sensitive unit by fusion splicing;
the motion control module comprises a three-dimensional displacement platform as pedestal, an optical fiber five-dimensional displacement platform, an optical fiber clamping member, a sensitive unit clamping member, a rotating platform, and a sensitive unit three-dimensional displacement platform; the optical fiber five-dimensional displacement platform and the sensitive unit three-dimensional displacement platform are fixed on the three-dimensional displacement platform as pedestal; the optical fiber clamping member is fixed on the optical fiber five-dimensional displacement platform; the sensitive unit clamping member is fixed on the rotating platform, and the rotating platform is fixed on the sensitive unit three-dimensional displacement platform; the optical fiber clamping member is configured to clamp the optical fiber pigtail, and the sensitive unit clamping member is configured to clamp the sensitive unit;
the optical fiber five-dimensional displacement platform is configured to cooperate with the sensitive unit three-dimensional displacement platform so as to achieve the alignment between the sensitive unit and the tail end of the optical fiber pigtail; the three-dimensional displacement platform as pedestal is configured to achieve the alignment between a fusion splicing position of the sensor and a focusing spot of the fusion splicing laser; and the rotating platform is configured to rotate the sensitive unit clamping member in a plane perpendicular to a direction of the optical fiber pigtail so as to achieve the switching of the fusion splicing position; and
the signal detection module comprises a detection light source, a circulator and a spectrometer; the detection light source is connected to the optical fiber pigtail through the circulator, detection laser outputted by the detection light source is transmitted to the sensitive unit through the circulator and the optical fiber pigtail and is reflected back and forth between the sensitive unit and an end surface of the optical fiber pigtail to form dual-beam interference; and an interference signal outputted by the optical fiber pigtail is transmitted to the spectrometer through the circulator, and a spectral signal of the sensor is monitored in real time by the spectrometer.

2. The coupling and packaging device for an integrated high-temperature optical fiber sensor based on laser fusion splicing according to claim 1, wherein the laser fusion splicing module comprises a carbon dioxide laser device, a controller, a first light guide unit, a first variable beam expander and a first focusing lens; the controller is configured to adjust power of the laser outputted by the carbon dioxide laser device and time when the carbon dioxide laser device outputs the laser; laser outputted by the carbon dioxide laser device passing through the first light guide unit, the first variable beam expander and the first focusing lens is incident and focused to the fusion splicing position; and the first variable beam expander is configured to adjust a size of a spot of a laser beam, and the first focusing lens is configured to focus the laser beam.

3. The coupling and packaging device for an integrated high-temperature optical fiber sensor based on laser fusion splicing according to claim 2, wherein the laser fusion splicing module further comprises a beam splitter prism, a second light guide unit, a second variable beam expander, and a second focusing lens, the laser outputted by the carbon dioxide laser device passing through the first light guide unit is incident to the beam splitter prism and is divided into two beams by the beam splitter prism, and one of the beams passing through the first variable beam expander and the first focusing lens is incident and focused to the fusion splicing position, and the other one of the beams passing through the second light guide unit, the second variable beam expander, and the second focusing lens is incident and focused to another fusion splicing position.

4. The coupling and packaging device for an integrated high-temperature optical fiber sensor based on laser fusion splicing according to claim 3, wherein the first light guide unit and the second light guide unit each comprise two 45° reflectors.

5. The coupling and packaging device for an integrated high-temperature optical fiber sensor based on laser fusion splicing according to claim 1, further comprising an electron microscope and a display screen, wherein the electron microscope is connected to the display screen and is configured to observe the fusion splicing position and a fusion splicing state of the sensor in real time.

6. The coupling and packaging device for an integrated high-temperature optical fiber sensor based on laser fusion splicing according to claim 1, wherein a sensitive unit clamping area and a capillary tube clamping area are arranged on the sensitive unit clamping member; the capillary tube clamping area is configured to fix a capillary tube, and the optical fiber five-dimensional displacement platform is further configured to move the tail end of the optical fiber pigtail to achieve the alignment between the optical fiber pigtail with the capillary tube; and the sensitive unit clamping area is configured to fix the sensitive unit.

7. The coupling and packaging device for an integrated high-temperature optical fiber sensor based on laser fusion splicing according to claim 6, wherein the sensitive unit clamping member comprises a U pedestal, a first slide rail and a second slide rail are arranged in the U pedestal, a first slide block is arranged on the first slide rail, a second slide block is arranged on the second slide rail, and a first guide screw and a second guide screw are arranged on a side wall of the U pedestal; an end of the first guide screw contacts with the first slide block to push the first slide block to slide along the first slide rail, so as to fix the sensitive unit; and an end of the second guide screw contacts with the second slide block to push the second slide block to slide along the second slide rail so as to fix the capillary tube.

8. The coupling and packaging device for an integrated high-temperature optical fiber sensor based on laser fusion splicing according to claim 1, wherein the detection light source is an ASE light source, with a wavelength of 1550 nm.

9. A coupling and packaging method for an integrated high-temperature optical fiber sensor based on laser fusion splicing, implemented based on the coupling and packaging device according to claim 1, wherein the method comprises the following steps:
step 1: cleaning the sensitive unit and the capillary tube respectively and fixing the sensitive unit and the capillary tube in the sensitive unit clamping area and the capillary tube clamping area, and flatly cutting an end surface of the optical fiber pigtail and fixing the optical fiber pigtail to the optical fiber clamping member;
step 2: controlling the optical fiber five-dimensional displacement platform to move, so as to insert the optical fiber pigtail into the capillary tube, and keeping the end surface of the optical fiber flush with the end surface of the capillary tube;
step 3: controlling the three-dimensional displacement platform as pedestal to move so as to achieve the alignment between the fusion splicing position between the optical fiber pigtail and the capillary tube and the focusing spot of the fusion splicing laser; and controlling power of the laser outputted by the laser fusion splicing module and time when the laser fusion splicing module outputs the laser so as to achieve the fusion splicing between the capillary tube and the optical fiber pigtail;
step 4: after the fusion splicing of the capillary tube and the optical fiber pigtail is completed, taking out the capillary tube from the capillary tube clamping area, controlling the optical fiber five-dimensional displacement platform to move so as to insert the capillary tube into the sensitive unit; and controlling the three-dimensional displacement platform as pedestal to move so as to achieve the alignment between the fusion splicing position between the optical fiber pigtail and the capillary tube and the focusing spot of the fusion splicing laser;
step 5: monitoring an interference signal of the sensor in real time by the signal monitoring module, adjusting the optical fiber five-dimensional displacement platform and the sensitive unit three-dimensional displacement platform so as to change a relative angle and position between the capillary tube with the pigtail and the sensitive unit, until the interference signal detected by the signal monitoring module is the strongest; and then controlling the power of the laser outputted by the laser fusion splicing module and the time when the laser fusion splicing module outputs the laser so as to achieve the preliminary fusion splicing between the capillary tube and the sensitive unit; and
step 6: after the preliminary fusion splicing between the capillary tube and the sensitive unit is completed, releasing the optical fiber clamping member, controlling the rotating platform to rotate to drive the capillary tube and the sensitive unit to rotate, and performing fusion splicing on a next fusion splicing position between the capillary tube and the sensitive unit.

10. The coupling and packaging method for an integrated high-temperature optical fiber sensor based on laser fusion splicing according to claim 9, wherein step 3 specifically comprises the following steps:
step 3.1: controlling the three-dimensional displacement platform as pedestal to move so as to achieve the alignment between the fusion splicing position between the optical fiber pigtail and the capillary tube and the focusing spot of the fusion splicing laser; and controlling the power of the laser outputted by the laser fusion splicing module and the time when the laser fusion splicing module outputs the laser so as to achieve the fusion splicing between the capillary tube and the optical fiber pigtail; and
step 3.2: controlling the three-dimensional displacement platform as pedestal to move along an axial direction of the optical fiber pigtail so as to achieve the alignment between a next axial fusion splicing position between the optical fiber pigtail and the capillary tube and the focusing spot of the fusion splicing laser, then controlling the power of the laser outputted by the laser fusion splicing module and the time when the laser fusion splicing module outputs the laser so as to achieve the fusion splicing between the capillary tube and the optical fiber pigtail, and then repeating the above steps so as to achieve the multi-position fusion splicing between the capillary tube and the optical fiber pigtail; and
step 6 specifically comprises the following steps: after the preliminary fusion splicing between the capillary tube and the sensitive unit is completed, releasing the optical fiber clamping member, controlling the rotating platform to rotate to drive the capillary tube and the sensitive unit to rotate, controlling the three-dimensional displacement platform as pedestal to move so as to achieve the alignment between a next fusion splicing position on a same circumference between the optical fiber pigtail and the capillary tube and the focusing spot of the fusion splicing laser, and performing fusion splicing on the next fusion splicing position between the capillary tube and the sensitive unit.
